(19) United States
(12) Patent Application Publication
(10) Pub. No.: US 2026/0165225 A1
(43) Pub. Date: Jun. 18, 2026

(54) PNEUMATIC FERTILIZER SPREADER AND METHOD FOR OPERATING A PNEUMATIC FERTILIZER SPREADER

(71) Applicant: HORSCH LEEB Application Systems Gmbh, Landau an der Isar (DE)

(72) Inventor: Fabian SALLER, Osterhofen (DE)

(73) Assignee: HORSCH LEEB Application Systems Gmbh, Landau an der Isar (DE)

(21) Appl. No.: 19/423,647

(22) Filed: Dec. 17, 2025

(30) Foreign Application Priority Data
Dec. 18, 2024 (DE) 10 2024 138 602.9

(51) Int. Cl. A01B 73/06; A01C 7/08; A01C 7/20; A01C 15/04

(52) U.S. Cl. CPC A01B 73/06; A01C 7/081; A01C 7/20; A01C 15/04

(57) ABSTRACT

The invention relates to a pneumatic fertilizer spreader for applying granular material on agricultural land. The spreader includes at least one distribution linkage with several linkage sections and several distribution lines of different lengths, wherein the distribution lines can be supplied with an air volume flow generated by a flow generation device for conveying the material to be spread. At least two of the linkage sections are connected to each other by means of at least one joint so that they can rotate about a first axis of rotation oriented perpendicular to the longitudinal extent of the linkage sections.

### CROSS-REFERENCE TO RELATED APPLICATIONS

This application claims the benefit of German Patent Application No. DE 10 2024 138 602.9, filed Dec. 18, 2024, the disclosure of which is hereby incorporated herein in its entirety by reference.

### BACKGROUND OF THE INVENTION

### Field of the Invention

The invention relates generally to the field of agricultural spreaders. Specifically, the invention relates to a pneumatic fertilizer spreader and a method for operating a pneumatic fertilizer spreader.

### Background

Pneumatic fertilizer spreaders with large working widths of at least 24 metres are known from the prior art. As a result, when forces are exerted on the fertilizer spreader, the distribution linkage may move with a large amplitude at the ends of the distribution linkage, which may damage the linkage due to contact with the ground or the like, and, on the other hand, may prevent uniform distribution of fertilizer.

### SUMMARY OF THE INVENTION

The object of the invention is therefore to eliminate the disadvantages of the prior art described above. In particular, a pneumatic fertilizer spreader is to be provided which allows the distribution linkage to be adjusted depending on the forces acting on it. Advantageous embodiments and further developments of the invention are disclosed in the claims and the following description with partial reference to the figures.

The invention relates to a pneumatic fertilizer spreader for applying granular material on agricultural land, which comprises at least one distribution linkage with several linkage sections and several distribution lines of different lengths, wherein the distribution lines can be supplied with an air volume flow generated by a flow generation device for conveying the material to be spread.

The invention is distinguished in that at least two of the linkage sections are connected to each other by means of at least one joint so that they can rotate about a first axis of rotation oriented perpendicular to the longitudinal extent of the linkage sections.

The longitudinal extent is the axis along which the respective linkage section extends with its largest dimension. This means that the other dimensions, i.e. the height and width of the respective linkage section, are smaller than the longitudinal extent.

When the distribution linkage is unfolded, preferably during operation of the pneumatic fertilizer spreader, the longitudinal extent of the linkage section preferably extends transversely to the direction of travel of the pneumatic fertilizer spreader, or along a longitudinal extent of the fertilizer spreader, which preferably corresponds to the direction of travel. The first axis of rotation can be an axis of rotation oriented in the direction of travel, preferably during operation of the fertilizer spreader and/or when the distribution linkage is unfolded.

When the distribution linkage is folded in, preferably during transport, preferably road travel, or storage of the pneumatic fertilizer spreader, the longitudinal extent of the linkage sections no longer extends transversely to the direction of travel, but rather along the longitudinal extent and/or a height extension of the pneumatic fertilizer spreader, whereby the width of the fertilizer spreader can be reduced.

The at least one joint is designed to allow the at least two linkage sections to rotate about the first axis of rotation. Preferably, the at least one joint is designed to provide at least one degree of freedom for the movement of the at least two linkage sections relative to each other. Preferably, the at least one joint is formed by at least one pivot joint.

According to a preferred embodiment, it may be provided that the at least two linkage sections are rotatable relative to each other about a second, upright-oriented axis of rotation by means of the at least one joint.

It can preferably be provided that the at least one joint is designed to enable the rotation of the at least two linkage sections about the first axis of rotation and the second axis of rotation. This means that the joint has at least two degrees of freedom. Alternatively, it can be provided that the at least one joint is formed by two joints, each of which has at least one degree of freedom. Preferably, a first joint, which is designed to enable the rotation of the at least two linkage sections about the first axis of rotation, and a second joint, which is designed to enable the rotation of the at least two linkage sections about the second axis of rotation, may be provided.

The flow generation device is preferably formed by a fan operable at a variable speed, or by at least two or more fans, each operable at a variable speed. The fan may preferably be a centrifugal fan and/or the like.

According to a preferred embodiment, it can be provided that an open-loop and/or closed-loop control unit is designed to provided open-loop control and/or closed-loop control of the rotational speed of the flow generation device by means of a drive driving the flow generation device. Preferably, the drive is an electric, hydraulic and/or pneumatic drive. Preferably, the drive may be formed by at least one motor. The motor may, for example, be a hydraulic motor and/or an electric motor.

By providing open-loop and/or closed-loop control of the rotational speed of the flow generation device, the flow velocity of the generated air volume flow can be changed, whereby the air pressure in the distribution lines and/or an air flow divider device can also be changed automatically.

The air volume flow can be varied depending on the speed of the flow generation device.

Preferably, an air flow distributor can be provided which is coupled to the flow generation device and the distribution lines. Preferably, the air flow distributor is designed to distribute the air volume flow generated by the flow generation device to the distribution lines. In particular, the flow generation device may be coupled to the air flow distributor, preferably exclusively coupled to the air flow distributor, in order to provide a substantially equal pressure level in at least all distribution lines.

The flow generation device and/or the air flow distributor is/are preferably assigned to the distribution linkage, in particular a distribution linkage centre section, in particular spatially assigned. A spatial assignment can be achieved, for example, by a structural unit.

Preferably, a plurality of connecting lines having identical and/or different cross-sections are designed for the respective connection between the air flow distributor and the distribution lines. The connecting lines can be formed, for example, by connecting pieces. Alternatively or cumulatively, the connecting lines can be formed by line sections. Based on the connecting lines having the same and/or different cross-sections and the connecting ports having the same and/or different cross-sections, the speed of the supply air flow can be additionally variable.

According to a preferred embodiment, an open-loop control and/or closed-loop control unit may be provided which is designed to provide open-loop control and/or closed-loop control of an actuator coupled to the at least two linkage sections. Preferably, the at least one actuator is mechanically coupled to the at least two linkage sections.

Preferably, the at least one actuator is designed to rotate the at least two linkage sections by means of the at least one joint about the first axis of rotation oriented perpendicular to a longitudinal extent of the linkage sections.

By providing open-loop control and/or closed-loop control of the at least one actuator, the at least one actuator changes, for example, a length, a position, and/or the like, whereby the at least two linkage sections are rotated relative to each other about the first axis of rotation by means of the at least one joint.

The at least one actuator is designed to rotate the at least two linkage sections by means of the at least one joint about the second rotation axis, which is oriented vertically.

By providing open-loop control and/or closed-loop control of the at least one actuator, the at least one actuator changes, for example, a length, a position, and/or the like, whereby the at least two linkage sections are rotated relative to each other about the second axis of rotation by means of the at least one joint.

By providing open-loop control and/or closed-loop control of at least one actuator, which is designed to rotate the at least two linkage sections relative to each other, precise and user-friendly rotation of the at least two linkage sections can be achieved.

According to a further preferred embodiment, it can be provided that the open-loop and/or closed-loop control unit is designed to provide open-loop and/or closed-loop control of the at least one actuator on the basis of distances between the at least two linkage sections and the agricultural land, which are detected by sensor units associated with the at least two linkage sections.

Preferably, at least one sensor unit is assigned to each of the at least two linkage sections, wherein the respective sensor unit is configured to detect a distance between the respective linkage section and the agricultural land. Preferably, the respective sensor unit may comprise at least one sensor for detecting the distance. Preferably, the sensor unit may comprise at least one radar sensor, an ultrasonic sensor, a laser sensor, and/or any other sensor which is designed to detect the distance.

Preferably, the open-loop and/or closed-loop control unit is designed to provide open-loop and/or closed-loop control of at least one actuator on the basis of the detected distances of the respective one of the at least two linkage sections from the agricultural land.

This allows a certain safety requirement to be met. Preferably, the open-loop and/or closed-loop control unit is designed to provide open-loop and/or closed-loop control of the actuator on the basis of the detected distances in such a way that the respective distance lies within a predetermined distance range. This means that the open-loop and/or closed-loop control unit is designed to provide open-loop and/or closed-loop of the actuator in such a way that a minimum distance and/or a maximum distance cannot be exceeded. Preferably, the specified distance range can be specified by manual user input. Alternatively or cumulatively, the open-loop and/or closed-loop control unit is designed to define the specified distance range on the basis of crop population, preferably a growth height, the agricultural land and/or geometric dimensions, preferably a working width, of the fertilizer spreader.

According to a preferred embodiment, it may be provided that the open-loop and/or closed-loop control unit is designed to provide open-loop and/or closed-loop control of at least one actuator on the basis of the detected distances in such a way that at least one of the at least two linkage sections has a predeterminable distance to the agricultural land. Preferably, the predetermined distance can be specified by manual user input. Alternatively or cumulatively, the open-loop and/or closed-loop control unit is designed to define the predetermined distance based on the crop population, preferably the growth height, the agricultural land and/or geometric dimensions, preferably the working width, the arrangement of distribution elements on the distribution linkage, and/or the like, of the fertilizer spreader. The distribution elements are designed to distribute the material to be spread. Preferably, the distribution elements are arranged on the distribution lines, preferably on the outlet openings of the distribution lines.

According to a further preferred embodiment, at least one of the respective sensor units may be designed to detect the distance of the respective linkage section to the agricultural land in advance.

It is preferable for the distance to the agricultural land to be detected in advance by at least one sensor unit being arranged facing forwards from the distribution linkage, preferably with a detection range of the at least one sensor unit being arranged facing forwards. This means that the detection range of the at least one sensor unit is arranged at least partially in front of the distribution linkage in the direction of travel.

Preferably, the open-loop and/or closed-loop control unit is designed to provide open-loop and/or closed-loop control of at least one actuator on the basis of the distances detected in advance. Preferably, the open-loop and/or closed-loop control unit is designed to provide open-loop and/or closed-loop control of at least one actuator in advance on the basis of the distances detected in advance. This means that the at least one actuator is open-loop and/or closed-loop controlled in advance so that when the position corresponding to the detected distance ahead is reached, the corresponding open-loop and/or closed-loop control of the at least one actuator has already started or starts without further delay due to reaction times and/or the like.

According to a further preferred embodiment, it may be provided that at least one of the sensor units is designed to detect a movement, preferably a speed and/or an acceleration, of the respective linkage section towards or away from the agricultural land, wherein the open-loop and/or closed-loop control unit is designed to provide open-loop and/or closed-loop control of the at least one actuator for the rotation of the at least two linkage sections about the first axis of rotation on the basis of the detected movement.

Preferably, the open-loop and/or closed-loop control unit is designed to determine, based on the detected movement towards or away from the agricultural land, how the at least one actuator must be open-loop and/or closed-loop controlled, for example, whether the at least one actuator must be shortened or extended in its length. Preferably, the open-loop and/or closed-loop control unit is designed to provide open-loop and/or closed-loop control of the at least one actuator in terms of the force it needs to provide, based on a detected speed and/or detected acceleration. This helps to avoid a collision with the agricultural land. Preferably, the open-loop and/or closed-loop control unit can be designed to progressively provide open-loop and/or closed-loop control of at least one actuator.

According to a further preferred embodiment, it may be provided that the distribution lines extend along the at least two linkage sections. Preferably, the distribution lines are fixedly connected to the at least two linkage sections.

Preferably, at least part of the distribution lines may extend over the at least two linkage sections. Preferably, it may be provided that the distribution lines extending over the at least two linkage sections are formed from at least two distribution line sections that can be detachably connected to each other by means of at least one detachable connection, preferably a plug connection. Preferably, the plug connection is a sleeve connection.

This is preferred for switching between operation of the pneumatic fertilizer spreader and transport of the pneumatic fertilizer spreader.

Furthermore, the respective distribution line sections may preferably be designed to be rigid, at least in sections, whereby the influence of curved sections on the air volume flow can be reduced for the respective distribution line section. Preferably, the rigid distribution line sections can reduce wear, as they can be made of hard or resistant material and/or designed to run straight. The positioning of the respective distribution line sections relative to the distribution linkage and/or the crop population and/or the agricultural land can also be improved by the at least partially rigid design of the respective distribution lines.

Since the respective distribution line sections are rigid, a correspondingly detachable connection is necessary. In order to enable a repeatable connection between the respective distribution line sections, it is provided that the distribution line sections can be detachably connected to each other by means of a detachable connection, preferably a plug connection.

According to a further preferred embodiment, it may be provided that the open-loop and/or closed-loop control unit is designed to provide open-loop and/or closed-loop control of at least one actuator by means of at least one rotation limiter for limiting the rotation of the at least two linkage sections about the first axis of rotation.

Preferably, the at least one rotation limiter is designed to limit the rotation of the at least two linkage sections about the first axis of rotation.

This is particularly advantageous if the respective distribution line sections are connected to each other by means of the detachable connection. It may happen that the open-loop and/or closed-loop control unit provides open-loop and/or closed-loop control of the at least one actuator in such a way that the detachable connection can be detached by the rotation of the at least two linkage sections. As a result, the respective distribution line sections are fluidically separated.

In order to prevent the detachable connections of the respective distribution lines from being loosened by the rotation of the at least two rod sections relative to each other, it is preferable to provide at least one rotation limiter which is designed to limit the rotation of the at least two rod sections relative to each other about the first axis of rotation.

According to a further preferred embodiment, it may be provided that the at least one rotation limiter is a mechanical rotation limiter and/or a software-based rotation limiter.

Preferably, the rotation limiter for limiting the rotation of the at least two linkage sections about the first axis of rotation may be at least one of: a specification of a maximum rotation angle of the at least two linkage sections when rotating about the first axis of rotation relative to each other, a specification of a maximum travel distance of the at least one actuator, and a mechanical limit.

Preferably, an angle detection device is provided which is designed to detect a rotation angle between the at least two linkage sections. Preferably, the angle detection device is designed to transmit the detected rotation angle to the open-loop and/or closed-loop control unit for further processing. Preferably, the open-loop and/or closed-loop control unit is designed to provide open-loop and/or closed-loop control of the at least one actuator on the basis of the detected rotation angle and/or the maximum rotation angle, preferably in such a way that the maximum rotation angle is not exceeded. Preferably, the angle detection device may comprise an angle sensor, preferably an angle potentiometer and/or further sensors, which are designed to detect a rotation angle.

Alternatively or cumulatively, a travel path detection unit may be provided which is designed to detect the travel path of at least one actuator. Preferably, the open-loop and/or closed-loop control unit is configured to provide open-loop and/or closed-loop control of at least one actuator on the basis of the detected travel distance and/or the maximum travel distance, preferably in such a way that the maximum travel distance is not exceeded.

Alternatively or cumulatively, it may be provided that the mechanical limitation is formed by an interaction system, which preferably comprises one or more stops. Preferably, the mechanical limitation may be variable in its effective path. Preferably, the interaction system may comprise at least one tongue and groove guide, wherein the tongue and groove guide is limited by the extension of the groove. Alternatively or cumulatively, further mechanical limitations are conceivable.

Preferably, the rotation limit may be designed such that when the at least two linkage sections rotate around the first axis of rotation relative to each other, the respective distribution line sections are or remain connected. the rotation limit, a disconnection between the respective distribution line sections can be prevented. Preferably, the at least one rotation limiter can be specified by manual user input of the open-loop and/or closed-loop control unit. It is preferable that the at least one rotation limiter is dependent on the detachable connection of the respective distribution line sections. For example, the sleeve element can specify how far the distribution line sections can move away from each other before the connection between the distribution line sections is detached.

According to a further preferred embodiment, at least one position detection device may be provided which is designed to detect the position of the at least two linkage sections relative to each other, wherein the open-loop and/or closed-loop control unit is designed to provide open-loop and/or closed-loop control of the at least one actuator on the basis of the detected position of the at least two linkage sections relative to each other.

In order to be able to provide open-loop and/or closed-loop control of the at least two linkage sections, preferably with regard to their distance from the agricultural land, it is necessary to detect how the at least two linkage sections are arranged relative to each other, i.e. to know the position of the at least two linkage sections. Depending on the detected position, the open-loop and/or closed-loop control unit is designed to control at least one actuator accordingly. Preferably, the open-loop and/or closed-loop control unit is designed to provide open-loop and/or closed-loop control of the at least one actuator on the basis of the detected position of the at least two linkage sections relative to each other and the detected distance between the at least two linkage sections, preferably by transmitting open-loop and/or closed-loop control signals to the at least one actuator.

According to a preferred embodiment, the distribution linkage may comprise a support device. Preferably, the support device may be coupled to a frame of the pneumatic fertilizer spreader and be designed to be height-adjustable relative to the frame.

The height adjustment may be implemented by means of a height adjustment unit, for example a parallelogram and/or a linear unit arranged between the frame and a support device. At least one actuator (e.g. one or more hydraulically and/or pneumatically operated linear drives such as cylinders or the like) may be assigned to the parallelogram and/or the linear unit in order to change the distance to the reference surface, i.e. to pivot the parallelogram or to adjust the linear unit.

Preferably, the height of the distribution linkage can be changed by means of the height adjustment unit.

Preferably, the adjustment unit is designed to change the height of the distribution linkage relative to the reference surface, for example the agricultural land, by changing the at least one actuator of the height adjustment unit.

The height adjustment unit, preferably the parallelogram and/or the linear unit, may be a useful component of the distribution linkage or, in particular, may be connected to the support device of the distribution linkage with the parallelogram and/or the linear unit.

According to a further preferred embodiment, the distribution linkage may be provided with a central linkage section. Preferably, the central linkage section is rotatably coupled to the support device about an axis of rotation oriented in the direction of travel. This allows the distribution linkage to follow forces acting on it.

Preferably, the adjustment unit is designed to change the rotational position of the distribution linkage by means of the rotatable coupling of the distribution linkage to the support device. Preferably, the change in the rotational position of the distribution linkage comprises an open-loop and/or closed-loop control of the rotational position of the distribution linkage. Preferably, a sensor device is provided and designed to detect the rotational position of the distribution linkage. Preferably, the adjustment unit is designed to carry out the change in the rotational position on the basis of the detected rotational position.

Preferably, at least one actuator is provided which is coupled to the carrier device and the distribution linkage, and wherein the changing unit is designed to influence the actuator, preferably on the basis of the detected rotational position of the distribution linkage.

According to a further preferred embodiment, it may be provided that the metering device is spatially assigned to the distribution linkage. A spatial assignment can be achieved, for example, by means of a structural unit. Preferably, it may be provided that the metering device is coupled to the carrier device and/or the middle part of the linkage.

Preferably, the distribution linkage may have at least two booms, each of which is rotatably coupled to the central linkage section about an upright axis of rotation.

According to a further preferred embodiment, it may be provided that one of the plurality of linkage sections is a linkage centre section.

Preferably, it may be provided that the at least two linkage sections each form a boom of the distribution linkage and are each rotatably coupled to the linkage centre section by means of a first axis of rotation; and/or each form a boom of the distribution linkage and are connected to each other so as to be rotatable about the first axis of rotation.

According to the invention, the underlying task is solved by a method for operating a pneumatic fertilizer spreader, preferably a pneumatic fertilizer spreader according to at least one described embodiment. This method includes providing a pneumatic fertilizer spreader which has at least one distribution linkage with several linkage sections and several distribution lines of different lengths. The method further includes rotating the at least two linkage sections about a first axis of rotation oriented perpendicular to a longitudinal extent of the linkage sections by means of open-loop and/or closed-loop control of at least one actuator coupled to the at least two linkage sections on the basis of detected distances between the respective linkage section and an agricultural land.

In the context of the invention, the respective steps of the method can be carried out in a specified sequence, although it is also conceivable that the steps of the method can be carried out in any sequence. Any change between the method steps is also conceivable. In addition, it is also conceivable to supplement the method with further method steps.

Preferably, the steps of the method are carried out continuously and/or at intervals.

The open-loop and/or closed-loop control unit has, for example, a computer unit, an on-board computer and/or the like and also comprises an open-loop and/or closed-loop control circuit, in particular a hydraulic and/or pneumatic and/or electrical open-loop and/or closed-loop control circuit, wherein the open-loop and/or closed-loop control circuit is suitably designed for hydraulic and/or pneumatic and/or electrical signal and/or command transmission. This signal and/or command transmission can also be wireless (e.g. via WLAN).

In the context of the invention, the term “open-loop and/or closed-loop control unit” refers in particular to all components for signal and/or command transmission. This also includes computer units, CPUs and/or similar devices. Control devices integrated into the respective sensors, sensor units or sensor arrays are also included. It should also be noted that the signals and/or data from the sensors/measuring devices/detection devices and/or the like can be used as feedback for an open-loop and/or closed-loop controlled variable.

It should also be noted that the terms “open-loop control” and “closed-loop control” and “open-loop control device” and “closed-loop control device” and “open-loop and/or closed-loop control unit” can refer to electronic and/or pneumatic and/or hydraulic open-loop and/or closed-loop control systems, which, depending on their design, can perform open-loop control tasks and/or closed-loop control tasks. Even if the term “open-loop control” is used here, it may also include “closed-loop control” for the same purpose. Similarly, when the term “closed-loop control” is used, it may also include “open-loop control”.

With regard to the advantages and embodiments of the method according to the invention, reference is made to the advantages and embodiments of the pneumatic fertilizer spreader according to the invention.

For the purposes of the application, features disclosed in connection with other features may also be regarded as disclosed on their own. Features connected by “and/or” are to be understood as disclosed on their own and in combination with the other features.

To avoid repetition, it should be noted that the embodiments and features of the invention can be combined in any way and freely with the device and/or the method. Accordingly, all embodiments and features of the invention are disclosed and can be claimed for both the device and the method.

### DESCRIPTION OF THE DRAWINGS

Further details and advantages of the invention are described below with reference to the accompanying drawings. The relative sizes of the individual elements in the figures do not always correspond to the actual sizes, as some shapes are simplified and others are enlarged in relation to other elements for better illustration. In the drawings:

FIG. 1 shows a pneumatic fertilizer spreader according to one embodiment;

FIG. 2 shows the fertilizer spreader according to FIG. 1 in a side view;

FIG. 3 shows a detail of the distribution linkage;

FIG. 4 shows a detail of FIG. 3;

FIGS. 5 and 6 shows functionality of the fertilizer spreader.

### DETAILED DESCRIPTION OF THE PREFERRED EMBODIMENTS

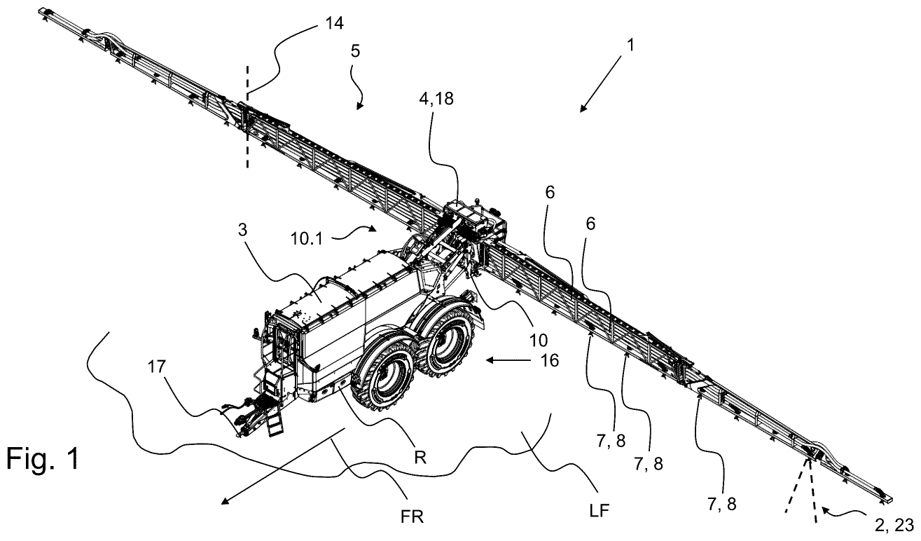

The embodiments shown in FIGS. 1 to 6 correspond at least in part, so that similar or identical parts are given the same reference signs and, in order to avoid repetition, reference is also made to the description of the other embodiments or figures for their explanation.

A variant of a pneumatic fertilizer spreader 1 is shown in the views in the figures. The pneumatic fertilizer spreader 1 can be used to spread, i.e. distribute, granular agricultural materials in particular in desired quantities on agricultural lands LF in an expedient manner. The materials to be spread include, for example, agricultural fertilizers and/or microgranules and/or seeds and/or similar.

The fertilizer spreader 1 is designed as a fertilizer spreader 1 pulled by a towing vehicle (e.g. a tractor not shown here), although the fertilizer spreader 1 can also be designed as a self-propelled fertilizer spreader 1 or as a fertilizer spreader 1 attached to a towing vehicle. The fertilizer spreader 1 could also be an autonomous vehicle (e.g. fully autonomous or partially autonomous) or be attached to an autonomous carrier vehicle.

The fertilizer spreader 1 comprises a frame R supporting the components of the fertilizer spreader 1, as well as at least one storage container 3 for carrying and/or supplying the material to be spread. Two or more storage containers 3 may also be provided for two or more, in particular different, materials to be spread, i.e. they may be attached to the frame R of the fertilizer spreader 1.

In order to achieve the greatest possible impact, i.e. to achieve a large working width, the fertilizer spreader 1 has a distribution linkage 5 extending transversely to the direction of travel FR over a large working width (e.g. 24 metres, 30 metres, 36 metres or more). The distribution linkage 5 has a support device 10 connected to the frame R, a linkage centre section 11 and booms 13 mounted on the linkage centre section 10 so that they can pivot relative to the linkage centre section 11. Preferably, each boom has at least one linkage section 12, which can be assembled so that it can rotate about vertically oriented axes. The linkage centre section 1 can also be referred to as a linkage section 12.

In order to comply with a permissible transport width (e.g. 3 metres in Germany), the booms 13 are mounted on the linkage centre section 10 so that they can pivot about vertically oriented axes 14.

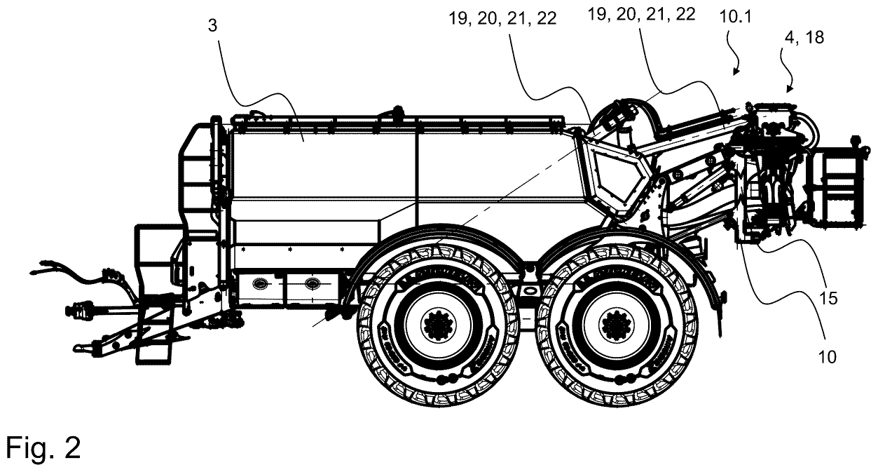

The distribution linkage 5, in particular its central linkage section 11, is mounted on the support device 10 by means of a bearing 15, which is shown schematically in FIG. 2, so that it can rotate transversely to the direction of travel FR about an axis of rotation oriented in the direction of travel relative to the frame R. The rotational position can be open-loop and/or closed-loop controlled in particular by means of an actuator, not shown here, which can be controlled by a control device, whereby the actuator can be mounted in particular between the middle part 11 of the linkage and the support device 10 and/or between the middle part 11 of the linkage and the frame R.

The frame R can also be advantageously designed in particular as a multi-part structure, whereby the individual parts can in turn be connected by means of a permanent (e.g. welding) and/or detachable (e.g. screws or similar machine elements) connection.

The frame R also comprises a running gear 16 with wheels, which, according to the embodiments, may in particular be a tandem running gear, and a connecting device 17 for connection to a towing vehicle. In addition, the storage container 3 is part of the frame R.

In order to adjust the height of the distribution linkage 5, the support device 10 is mounted on the frame R in such a way that its height can be adjusted by means of a height adjustment device 10.1, for example a parallelogram.

A metering device 4 with a metering container 18 is assigned to the centre section 11 of the distribution linkage 5; in particular, these form a structural unit. A conveyor system 19, which comprises a conveyor line and/or a conveyor device 20, opens into the metering container 18, but several conveyor lines and/or conveyor devices 20 could also open into the metering container 18 in order to be able to feed one, two or more different distribution goods into it.

Preferably, both the storage container 3 and the metering container 18 taper downwards in a funnel shape, with at least one outlet opening (not shown here) located at the lowest point in each case.

The outlet opening is formed by an opening in the respective container 3, 18, through which, for example, material to be spread is transferred from the storage container 3 into the conveyor system 19 and/or from the metering container 18 into the metering device 4, whereby the outlet opening thus simultaneously forms the inlet of the conveyor system 19 and/or the metering device 4.

The material to be spread from the metering device 4 is conveyed to the distribution elements 8 attached to the distribution linkage 5 by means of distribution lines 6 along the distribution linkage 5. During operation of the fertilizer spreader 1, the material to be spread is conveyed along the distribution lines 6 by means of an air volume flow, whereby the distribution lines 6 are coupled to a flow-generating device (e.g. one or more blowers such as centrifugal blowers, radial blowers, axial blowers, diagonal blowers, cross-flow blowers or the like) for this purpose, i.e. they are operatively connected.

A plurality of distribution lines 6 are attached along the distribution rod 5, to each of which a distribution element 8 is attached in accordance with the embodiments, However, two or more distribution elements 8 per distribution line 6 would also be conceivable or possible, whereby, according to the figures, each distribution line 6 has a distribution element 8 which is assigned to the respective outer end of the distribution line 6, which forms an outlet opening 7. The distribution lines 6 also have different lengths starting from the metering device 4, i.e. they extend in different lengths from the metering device 4 along the distribution linkage 5.

In order to achieve a compact distribution linkage 5, the distribution lines 6 are also arranged one above the other, i.e. a plurality of distribution lines 6 are arranged one above the other.

The distribution lines 6 are also attached to the distribution linkage 5 in a substantially symmetrical manner with respect to the linkage centre section 11. In addition, the respective opposing distribution elements 8 each have at least largely the same height position.

The distribution lines 6 also have separation points, not shown here, between the linkage centre section 11 and the booms 13 or between the linkage sections 12 of the booms 13.

The distribution elements 8 can be formed in particular by impact plates, against which the material to be spread is conveyed by means of the air volume flow and then distributed, for example, in a fan-shaped pattern by means of the impact plate, depending on how the impact plate is designed. However, the distribution elements 8 can also be formed by an arcuate end region of the distribution lines 6, which can thus act as impact plates.

The distances between the distribution elements 8 can be such that the spreading fans generated by the distribution elements 8 enable the material to be spread over the entire surface, in particular enabling the material to be spread without gaps.

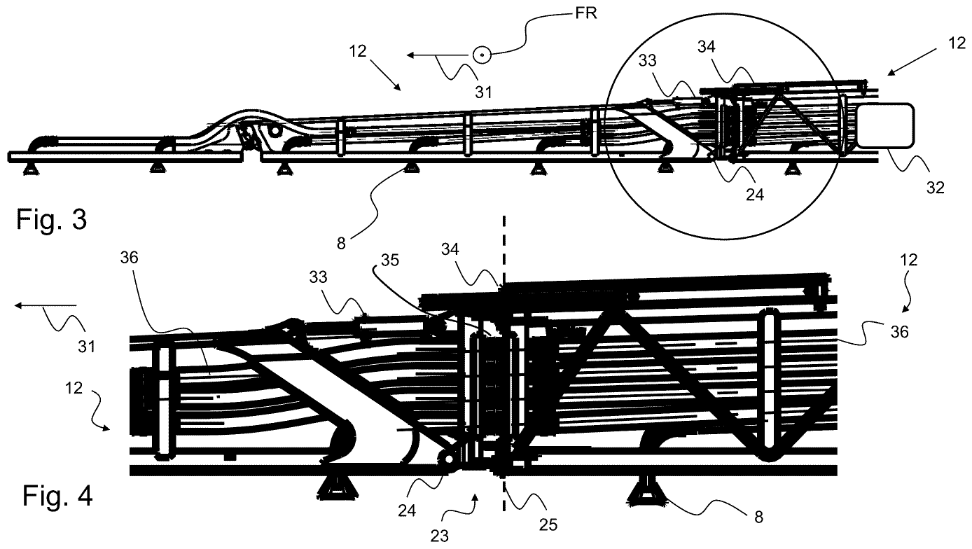

According to an alternative embodiment, it would also be conceivable for the distribution elements 8 to be arranged on the distribution linkage 5 in such a way or for the spreading fans generated by the distribution elements 8 to be such that the spreading fans overlap. For example, a double or triple overlap of the spreading fans can be provided, which in turn can increase the distribution quality, as shown in FIG. 3.

In order to supply the metering device 4 with the respective material to be spread, it is operatively connected to at least one storage container 3, whereby the operative connection can be made by means of a conveyor system 19 with, for example, a conveyor line 20 and by means of the metering container 18.

The conveyor system 19 according to the embodiments comprises a conveyor line 20 or conveyor device 20 opening into the metering container 18, but two or more conveyor lines 20 could also be provided, in particular for different materials to be spread.

The conveyor system 19, or the conveyor line 20 or the conveyor device 20, is divided into at least two parts, i.e. it has several conveyor sections 21, 22.

The conveyor system 19 and/or the conveyor sections 21, 22 may be formed by one or more screw conveyors and/or conveyor belts and/or the like.

Alternatively or additionally, the conveyor system may also be formed, at least in sections, by a pneumatic conveyor system in which the material to be spread is conveyed along the conveyor line 20 by means of an air volume flow.

The metering device 4 is assigned to the middle part 11 of the linkage and/or the carrier device 10 in such a way that it follows the vertical movements and/or the rotational movements of the distribution linkage 5 at least largely synchronously.

It is preferable that the pneumatic fertilizer spreader 1 comprises at least a frame R supporting components of the fertilizer spreader 1, a storage container 3 for carrying and supplying the material to be spread (e.g. seed, fertilizer and/or the like), a distribution linkage 5 extending transversely to the direction of travel FR, which distribution linkage 5 has a support device 10, a linkage centre section 11 and booms 13 rotatably attached to the linkage centre section 11, wherein distribution lines 6 with distribution elements 8 and a metering container 18 operatively connected to the storage container 3 by means of a conveyor system 19 are attached to the distribution linkage 5, wherein, in order to convey the material to be spread along the distribution lines 6 to the distribution elements 8, the distribution lines 6 can be supplied with an air volume flow and wherein, by means of at least one metering device 4 forming a structural unit with the distribution linkage 5 and operatively connected to the metering container 18, the material to be spread can be metered into the distribution lines 6.

It may be preferable for the distribution lines 6 on the distribution linkage 5 to be associated with a distribution system or at least two independent distribution systems, i.e. the independent distribution systems are independent in terms of distribution but may also have common components.

According to the invention, it is provided that at least two linkage sections 12 are connected to each other in a rotatable manner by means of at least one joint 23 about a first axis of rotation 24 oriented perpendicular to a longitudinal extent 31 of the linkage sections 12.

A section of the distribution linkage 5 with at least two linkage sections 12 can be seen in FIG. 3. A detailed view of FIG. 3 is shown in FIG. 4.

At least one actuator 33 is provided, which is coupled to the at least two linkage sections 12. The at least one actuator 33 is designed as a hydraulic cylinder. The actuator 33 is designed to rotate the at least two linkage sections 12 relative to each other about the first axis of rotation 24. An open-loop and/or closed-loop control unit 32 is also provided, which is designed to provide open-loop and/or closed-loop control of the at least one actuator 33, thereby achieving a rotation of the linkage sections 12 relative to each other.

Furthermore, the at least two linkage sections 12 are additionally connected to each other in a rotatable manner by means of the at least one joint 23 about a second, upright-oriented axis of rotation 25. According to FIGS. 3 and 4, the at least one joint 23 is formed by two joints.

In addition, a second adjustment device 34 is provided, which is designed to rotate the two linkage sections 12 about the vertically oriented axis of rotation 25 by means of the at least one joint 12.

At least some of the distribution lines 6 extend over the two linkage sections 12 and comprise at least two distribution line sections 3, which can be detachably connected to each other by means of a detachable connection 35. This is advantageous because the distribution lines 6 are at least partially rigid and therefore not sufficiently flexible when the rod sections 12 are rotated about the first axis of rotation 24 and/or second axis of rotation 25.

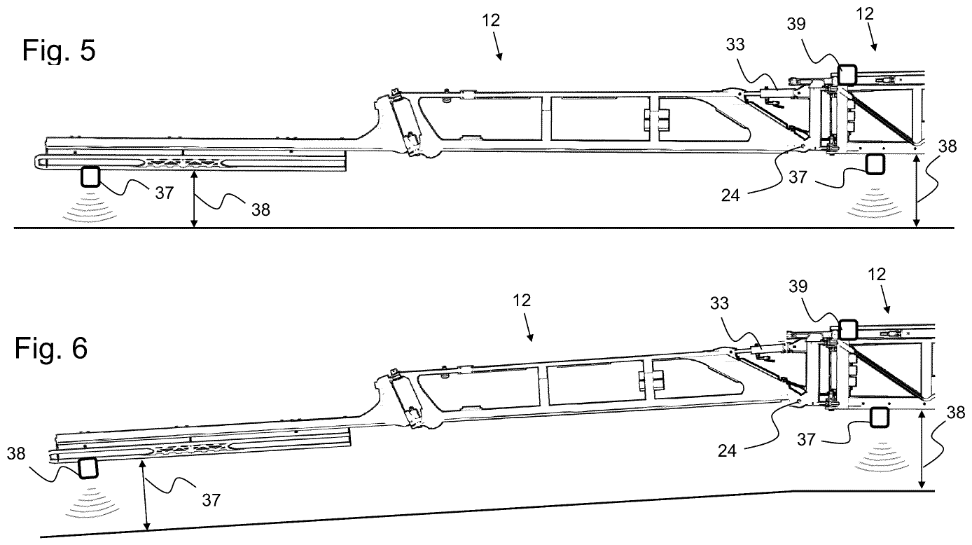

The functioning of the invention is further explained with reference to FIGS. 5 and 6.

The open-loop and/or closed-loop control unit 32 is designed to provide open-loop and/or closed-loop control of at least one actuator 33 on the basis of distances 38 between the at least two linkage sections 12 and the agricultural land LF, which are detected by sensor units 37 associated with the at least two linkage sections 12.

If the distance 38 to one or more linkage sections 12 changes, the open-loop and/or closed-loop control unit 32 provides open-loop and/or closed-loop control of the at least one actuator 33 accordingly, preferably in such a way that the linkage sections 12 have a predetermined distance 38 to the agricultural land LF.

A change in the distance 38 can occur due to a changing agricultural land LF, as shown in FIG. 6. If the area LF changes as shown, the distance 38 also changes, so that open-loop and/or closed-loop control of the actuator 33 is necessary in order to maintain a predetermined distance from the area LF.

A position detection device 39 is also provided for this purpose. The position detection device is designed to detect the position of the at least two linkage sections 12 relative to each other, whereby the open-loop and/or closed-loop control unit 32 is designed to provide open-loop and/or closed-loop control of the at least one actuator 33 on the basis of the detected position of the at least two linkage sections 12 relative to each other.

Although the invention has been described with reference to specific exemplary embodiments, it will be apparent to those skilled in the art that various modifications may be made and equivalents may be substituted without departing from the scope of the invention. In addition, many modifications may be made without departing from the scope of the invention. Consequently, the invention should not be limited to the disclosed exemplary embodiments, but should encompass all exemplary embodiments falling within the scope of the appended claims. In particular, the invention also claims protection for the subject matter and features of the dependent claims independently of the claims referred to.

What is claimed and desired to be secured by Letters Patent is:

1. A pneumatic fertilizer spreader for applying granular material on agricultural land, the fertilizer spreader comprising at least one distribution linkage with a plurality of linkage sections and several distribution lines of different lengths, wherein:
the distribution lines are supplied with an air volume flow generated by a flow generation device for conveying the material to be spread; and
at least two of the linkage sections are connected to each other by at least one joint so that they can rotate about a first axis of rotation oriented perpendicular to the longitudinal extent of the linkage sections.

2. The pneumatic fertilizer spreader according claim 1, further comprising an open-loop and/or closed-loop control unit configured to provide open-loop control and/or closed-loop control of at least one actuator coupled to the at least two linkage sections, wherein the at least one actuator is configured to rotate the at least two linkage sections by the at least one joint about a first axis of rotation oriented perpendicular to a longitudinal extent of the linkage section.

3. The pneumatic fertilizer spreader according to claim 2, wherein the open-loop and/or closed-loop control unit is configured to provide open-loop and/or closed-loop control of the at least one actuator based on distances between the at least two linkage sections and the ground, the distances being detected by sensor units associated with the at least two linkage sections.

4. The pneumatic fertilizer spreader according to claim 3, wherein the open-loop and/or closed-loop control unit is configured to provide open-loop and/or closed-loop control of the at least one actuator based on the detected distances such that at least one of the at least two linkage sections has a predeterminable distance to the ground.

5. The pneumatic fertilizer spreader according to claim 3, wherein at least one of the respective sensor units is designed to detect the distance of the respective linkage section to the ground in advance.

6. The pneumatic fertilizer spreader according to claim 3, wherein at least one of the respective sensor units is configured to detect a speed and/or an acceleration of its associated linkage section towards or away from the ground, and wherein the open-loop and/or closed-loop control unit is configured to provide open-loop and/or closed-loop control of the at least one actuator for the rotation of the at least two linkage sections about the first axis of rotation on the basis of the detected speed and/or acceleration.

7. The pneumatic fertilizer spreader according claim 1, wherein the distribution lines extend along the at least two linkage sections, wherein at least a part of the distribution lines extends over the at least two linkage sections and is formed from at least two distribution line sections that can be detachably connected to each other by at least one detachable connection, preferably a plug connection.

8. The pneumatic fertilizer spreader according claim 2, wherein the open-loop and/or closed-loop control unit is configured to provide open-loop and/or closed-loop control of the at least one actuator via at least one rotation limiter for limiting the rotation of the at least two linkage sections about the first axis of rotation.

9. The pneumatic fertilizer spreader according claim 8, wherein at least one rotation limiter for limiting the rotation of the at least two linkage sections is a specification of a maximum rotation angle of the at least two linkage sections relative to each other.

10. The pneumatic fertilizer spreader according claim 8, wherein at least one rotation limiter for limiting the rotation of the at least two linkage sections is a specification of a maximum travel distance of the at least one actuator.

11. The pneumatic fertilizer spreader according claim 8, wherein at least one rotation limiter for limiting the rotation of the at least two linkage sections is a mechanical limit.

12. The pneumatic fertilizer spreader according to claim 2, further comprising at least one position detection device configured to detect the position of the at least two linkage sections relative to each other, wherein the open-loop and/or closed-loop control unit is configured to provide open-loop and/or closed-loop control of the at least one actuator based on the detected position of the at least two linkage sections relative to each other.

13. The pneumatic fertilizer spreader according to claim 1, wherein the distribution linkage comprises a support device coupled to a frame of the fertilizer spreader, and wherein the support device is height-adjustable relative to the frame by a height adjustment unit.

14. The pneumatic fertilizer spreader according to claim 1, further comprising a metering device coupled to the distribution linkage, wherein the metering device is designed to meter material to be spread into the distribution lines.

15. The pneumatic fertilizer spreader according to claim 2, wherein the at least two linkage sections are rotatable relative to one another about a second, upright-oriented axis of rotation by the at least one joint.

16. The pneumatic fertilizer spreader according to claim 1, wherein one of the plurality of linkage sections is a linkage center section, and wherein the at least two linkage sections each form a boom of the distribution linkage and are each rotatably coupled relative to the linkage center section by a first axis of rotation.

17. The pneumatic fertilizer spreader according to claim 1, wherein one of the plurality of linkage sections is a linkage center section, and wherein the at least two linkage sections form a boom of the distribution linkage and are connected to each other so as to be rotatable about the first axis of rotation.

18. A method for operating a pneumatic fertilizer spreader according to claim 1, the method steps comprising:
providing a pneumatic fertilizer spreader having at least one distribution linkage with several linkage sections and several distribution lines of different lengths;
detecting a distance between at least one linkage section and the ground; and
rotating the at least two linkage sections by open-loop and/or closed-loop control of at least one actuator coupled to the at least two linkage sections, based upon the detected distance between the respective linkage section and the ground.
